(19) United States
(12) Patent Application Publication
(10) Pub. No.: US 2013/0159288 A1
(43) Pub. Date: Jun. 20, 2013

(54) INFORMATION GRAPH

(71) Applicant: Andrey N. Nikankin, St. Petersburg (RU)

(72) Inventor: Andrey N. Nikankin, St. Petersburg (RU)

(73) Assignee: RAWLLIN INTERNATIONAL INC.

(21) Appl. No.: 13/328,256

(22) Filed: Dec. 16, 2011

(51) Int. Cl. G06F 17/30

(52) U.S. Cl. 707/722; 707/E17.014

(57) ABSTRACT

Disclosed are electronic systems and techniques that generate an information graph with associated validation measures related to information obtained from data sources for providing recommendations about a potential candidate for a financial product. Search results are used to gather data associated with a potential client for loan offers. Levels of certainty are initiated from the associations and used to modify the search criteria or identifying data for searching further. A credit worthiness score related to the potential client is configured based on the information graph.

### TECHNICAL FIELD

The subject application relates to information graphs and dynamically generating information graphs related to a candidate.

### BACKGROUND

A number of consumers have experience with short term loans, payday advances, cash advances, and so forth. These types of financial instruments often require proof of employment and financial viability, such as a checking account and evidence of employment. Typically, the interest rate for such instruments can be high, due to the level of risk experienced by the lender. However, when a consumer needs to obtain a quick credit decision, there may be few alternatives except borrowing from pawn shops, friends, or family.

Additionally, consumers are frequently presented with opportunities to apply for instant approval of credit during internet shopping, or at the point of sale during traditional in-store shopping. Often the consumer can charge a current purchase to the new account if they are approved, and may be able to take advantage of one or more promotions for applying. However, consumers having little, or no, credit history are unlikely to be approved for these credit cards, such as with college students trying to start careers for the first time or groups of elderly always wary of credit. In addition, some consumers choose not to use credit cards, or elect not to go through the application process at the time that the offer is presented.

Moreover, retailers often attempt to persuade consumers to purchase additional items, or items related to items that the consumer is purchasing. In order to tailor the suggestions to the desires of the consumer, some retailers employ loyalty cards that enable the retailer to monitor the buying patterns of the consumer. Similarly, online retailers often encourage consumers to maintain a user account with the retailer, and data tracked via the user account can be used to suggest purchase options, or tailor promotions based on the consumer's buying patterns. However, similar to instant credit card applications, some consumers choose not to go through the loyalty card application or online account setup process.

The above-described deficiencies of today's credit application and promotional tools lend for the need to better serve and target potential clients or candidates for financial instruments. The above deficiencies are merely intended to provide an overview of some of the problems of conventional systems, and are not intended to be exhaustive. Other problems with conventional systems and corresponding benefits of the various non-limiting embodiments described herein may become further apparent upon review of the following description

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments for dynamically generating an information graph based on automatic augmentation of searched attributes and certainty information are contained herein. An exemplary method comprises executing, by a computing device including at least one processor, a search of a first set of data that is related to a first candidate for a financial offer. The first set of data is associated with a first level of certainty and the first set of data is transformed into a first data cluster for representation in display based on the first set of data and the first level of certainty. The method includes executing, by the computing device, a different search of a second set of data related to a second candidate, and associating the second set of data with a second level of certainty. The second set of data is transformed into a second data cluster for representation in display based on the second set of data and the second level of certainty. The method includes generating an information graph with the first data cluster and the second data cluster for further representation in display, and determining associations of the information graph between the first data cluster and the second data cluster. Based on the associations, the method includes determining whether to merge the first data cluster and the second data cluster in the information graph into a merged data cluster that is associated with the first candidate.

In another non-limiting embodiment, an exemplary computer readable storage medium having computer executable instructions that, in response to execution by a computing system, cause the computing system to perform operations that comprise executing, via a search engine, a search of one or more data sources and retrieving a set of data related to a candidate. The operations include associating a level of certainty to one or more data elements of the set of data, and transforming, for display in the computing system, the set of data into a data cluster based on the one or more data elements and the level of certainty. The transforming operation includes generating a candidate node associated with the candidate, generating one or more element nodes of the one or more data elements, and generating one or more edges that respectively connect the candidate node with the one or more element nodes and that include the level of certainty for the one or more data elements of the set of data. The operations include executing, via the search engine, a search for data elements of a plurality of different candidates, and transforming, for display in the computing system, the data elements of the plurality of different candidates into different data clusters associated with different candidates. An information graph is generated with the data cluster and the different data clusters in the display, and associations are determined in the information graph between the data cluster and the different data clusters. Based on the associations, the operations include determining whether to merge the data cluster with at least one of the different data clusters in the information graph into a merged data cluster.

In yet another non-limiting embodiment, an exemplary system is provided that comprises a search engine configured to generate search results with a computing device including at least one processor, wherein the search results have a first set of data that is related to a first candidate and a second set of data related to a second candidate. A certainty level component is configured to associate the first set of data with a first level of certainty, and the second set of data with a second level of certainty. A transformation component is configured to transform, for representation in display, the first set of data into a first data cluster based on the first set of data and the first level of certainty and the second set of data into a second data cluster based on the second set of data and the second level of certainty. An information graph component is configured to generate an information graph for further representation in display with the first data cluster and the second data cluster, and a merging component is configured to determine associations of the information graph between the first data cluster and the second data cluster, and to determine, based on the associations, whether to merge the first data cluster and the second data cluster in the information graph into a merged data cluster that is associated with the first candidate.

In yet another non-limiting embodiment, an exemplary system is provided that includes means for searching to retrieve data elements of a set of data related to a candidate from a set of data sources and for different data elements of a plurality of different candidates, means for associating respectively a level of certainty to the data elements of the set of data and different levels of certainty to the data elements of the plurality of different candidates, means for transforming the set of data into a data cluster based on the set of data and the level of certainty and transforming the data elements of the plurality of different candidates into different data clusters, means for generating an information graph with the data cluster and the different data clusters for representation in display, and means for determining associations in the information graph between the data cluster and the different data clusters and determining whether to merge the data cluster with at least one of the different data clusters in the information graph into a merged data cluster.

The following description and the annexed drawings set forth in detail certain illustrative aspects of the disclosed subject matter. These aspects are indicative, however, of but a few of the various ways in which the principles of the innovation may be employed. The disclosed subject matter is intended to include all such aspects and their equivalents. Other advantages and distinctive features of the disclosed subject matter will become apparent from the following detailed description of the innovation when considered in conjunction with the drawings.

### BRIEF DESCRIPTION OF DRAWINGS

Non-limiting and non-exhaustive embodiments of the subject disclosure are described with reference to the following figures, wherein like reference numerals refer to like parts throughout the various views unless otherwise specified.

FIG. 1 illustrates an example recommendation system in accordance with various aspects described herein;

FIG. 2 illustrates another example recommendation system in accordance with various aspects described herein;

FIG. 3 illustrates an exemplary non-limiting implementation of an information graph for compiling information dynamically;

FIG. 4 illustrates an exemplary non-limiting implementation of an information graph for compiling information dynamically;

FIG. 5 illustrates an example graphical relationship for determining certainty level information dynamically in accordance with various aspects described herein;

FIG. 6 illustrates another example recommendation system in accordance with various aspects described herein;

FIG. 7 illustrates an example advisor component in accordance with various aspects described herein;

FIG. 8 a flow diagram showing an exemplary non-limiting implementation for generating an information graph dynamically;

FIG. 9 is a block diagram representing exemplary non-limiting networked environments in which various non-limiting embodiments described herein can be implemented; and

FIG. 10 is a block diagram representing an exemplary non-limiting computing system or operating environment in which one or more aspects of various non-limiting embodiments described herein can be implemented.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon such as with a module, for example. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

In consideration of the above-described deficiencies among other things, various embodiments are provided that dynamically mine data related to clients, and, more generally, is related to generating an information graph, search engines, and information collected to generate the information graph.

To determine the credit worthiness of a client for a small loan, a large loan or some other financial instrument, information pertaining to the client's credit score is compiled into an information graph. Data sources are searched with trusted information to obtain search results, in which the information graph is dynamically updated with. Components are operable to process information from data sources and extract data about a candidate from online sources, such as HyperText Markup Language (HTML) pages. Candidates are discovered for financial products and stored (e.g., a hadoop distributed file system (HDFS)) with an indication a level of certainty that the information belongs to a particular candidate. After subsequent candidates are discovered, attributes (e.g., data elements) of a first candidate or a subject person are dynamically updated.

Each source of data elements has a factor of reliability (e.g., 0 . . . 1). For example, LinkedIn could be assigned a 1 or another factor that indicates a reliable source since information from this source has a low level of falsification. As such, LinkedIn is deemed a reliable source of data related to a given candidate. Other components generate an information graph in a display and store the information graph in a memory. The information graph includes a subject candidate or person, additional candidates, and data elements (e.g., candidate characteristics or candidate attributes) respectively linked to the subject candidate or additional candidates with a edge based on the reliability of each characteristic

Levels of certainty are assigned to the edges and are compiled in the information graph. These measures include scores that rank/rate certainty and relevancy of the different data elements related to a respective candidate. In return, an advisor component determines an offer to a candidate based at least in part on the information graph.

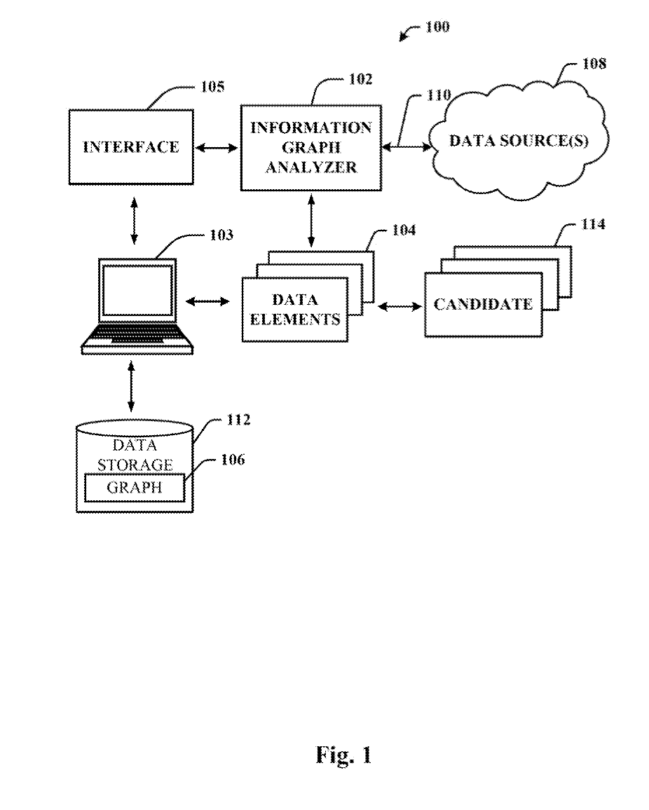

Referring initially to FIG. 1, illustrated is an example system 100 to output one or more recommendations pertaining to potential candidates in accordance with various aspects described herein. The system 100 is operable as a recommendation system, such as to recommend credit to potential clients or to output other recommendations based on analysis of a dynamically generated information graph and certainty of the data related to the client profile.

For example, the system 100 includes an information graph analyzer 102 that is operable to output an information graph related to a search subject with certain client or identifying data 104 (e.g., a potential client), provide analysis of the information graph outputted and dynamically update the information graph as additional information is collected. For example, a loan can be offered to a potential client based upon dynamically updated and validated data retrieved at a communication link 110 from data sources(s) 108. The information graph analyzer 102 is configured to retrieve search results from data sources 108, to generate an information graph 106 in a data storage 112 that provides attributes or characteristics associated with a client or a candidate 114 for a financial offer and different associations with other candidates 114. The information graph analyzer 102 ranks the data elements according to a validation measure, such as a level of certainty. For example, the information graph analyzer 102 obtains data elements 104 relating to one or more candidates 114, and dynamically generates a cluster of candidate data elements in the information graph 106 based at least in part on the data obtained. In addition, the information graph analyzer 102 classifies, decides, or otherwise determines an eligibility of a candidate 114 for one or more offers based at least in part on the information graph 106.

In one embodiment, the analyzer 102 receives one or more candidate data associated with a client 104, which is used as search data or key search terms for initial searches or for subsequent searches that update the validity of the data already retrieved and/or augment the data elements already retrieved relative to a particular candidate 114. For example, the candidate data can include identifying data such as a client's name, a date of birth, an email address, a geographical region, a home address, a phone number, a gender, a symbol and the like. Other identifying data may also be included, such as a history of transactions with a vendor or user of the recommendation system. For example, where a loan processing recommendation is the desired output from the recommendation system, the identifying data searched may be the history of usage with the financial services of the financial institution or lender.

The information graph analyzer 102 acquires data elements 104, for example, that relate to a person that is a potential client by searching a set of data sources 108, and collecting a set of search results, which are then used to generate and update the information graph 106. A computing device 103 with a processing unit has an interface 105 communicatively coupled thereto, such as a user interface, GUI or the like and further provides interaction with the information graph 106. The initial data elements 104 may be any data known about the client, such as a name or symbol to such as data retrieved from official data sources 108 that are private and/or public sources. For example, data elements 104 may be from various credit agencies (e.g., TranUnion, Experion, and Equifax), vendor stored databases, or any other official/private data source and is used as the initial identifying data for searching the potential client among public data sources or data sources that are always publically available. Additionally, data that may be initially searched with high reliability may be a client's name, email address, geographical address, transaction history and the like.

The information graph analyzer 102 is operable therefore as a candidate analyzer component to start analysis of a person as a potential client for a business loan, for example, or other financial product. The information graph analyzer 102 connects to the data sources 108 via a communication link 110 (e.g., comm link, network connection, etc). For example, the information graph analyzer 102 can obtain a set of data with the data elements 104 relating to various candidates 114 by querying one or more internet search engines. The information graph analyzer 102 inspects information included in the set of search results, and generates the information graph 106 with the set of data having data elements 104 that correspond to a candidate 114 of interest (e.g., a first candidate) as well as various other candidates that may or may not relate to the candidate of interest. The information graph analyzer 102 is configured to determine that a set of information in the search results is relevant to the potential client, and includes the set of information in the information graph 106 as data elements with connecting edges to each candidate 114 represented by one or more candidate nodes (not shown).

In another embodiment, the data elements 104 within the information graph 106 stored in data storage 112 is further ranked according to a level of certainty and is augmented to the first set of identifying data for further defining search terms in further searches for information pertaining to the client. For example, a name may be used to generate a first set of search results for the set of information stored as data elements 104 that are displayed in the information graph 106 on a display of the computing device 103. The data elements 106 can be weighted or associated with the name to varying degrees so that the weight of each association, for example, may vary depending upon the manner in which the data elements relate to the name. For example, a frequency or a number of times the name is associated with each search result may be ranked together and in addition based upon data accumulated in an aggregate in the data storage 112. For example, an alias or nickname for the name being searched may appear a number of times over multiple searches over time, and/or be a search result that is generated in conjunction with other metadata, and thus, indicate a higher likelihood that the data is correct or valid.

The level or levels of certainty include a reliability score that could be in different forms and is not limited to any one weight mechanism. For example, a weighted mechanism can include a binary digit (0 . . . 1), decimal digit, any other numbering system of a different base, a scale (e.g., from one to ten), graphical weight, and the like. Each level of certainty thus provides an indication of a reliability of an associated between data stored and a particular candidate 114, while each subsequent search further refines the validation strength of identifying data stored in the data elements 104. For example, the information graph analyzer 102 is configured to update the data of the information graph by a dynamic updating of the validity measure or level of certainty for each data element based on a subsequent set of search results.

In another embodiment, the level of certainty associated with the data elements of a particular candidate 114 or different candidates is provided in the information graph according to associations identified between each candidate 114 and each data element related to each particular candidate 114. For example, each candidate 114 among a plurality of candidates is represented as a candidate node within the graph 106 and connections, represented as edges between the nodes and the data elements, have the level of certainty associated to each edge. The levels of certainty between each association are based, for example, on a reliability of a data source from which the data elements of the respective candidates are retrieved in search results. For example, data sources that may be reliable may be social websites, professional sites, as well as other websites. In addition, as discussed above the levels of certainty in the information graph 106 are factored with a reliability of association between a candidate 114 and the data elements associated with the candidate.

The data retrieved, for example, comprises the search results for each search that is generated with modified or augmented identifying data from the information graph 106 compiled from previous searches of data sources. While the level of certainty, for example, varies according to fuzzy logic variables, analog logic, digital logic inputs, rule based values, neural network controls and the like, the resulting level of certainty measure is updated and changed with each set of search results for further refining the accuracy of validity and relevancy of the data found as it relates to the client.

In one embodiment, the information graph analyzer 102 can determine the client's 104 offer eligibility for a loan, for example, based on the information graph 106 satisfying a set of predetermined criteria. The predetermined criteria include validity and relevance of the data that has been updated by modified searching or augmented search data. For instance, if the information graph 106 satisfies a predetermined set of loan criteria, then the information graph analyzer 102 can determine that a candidate 114 is eligible for one or more loans. It is to be appreciated that although the information graph 106 is illustrated as being stored in a data store 112, such implementation is not so limited. For instance, the information graph analyzer 106 can be associated with an online shopping portal, stored in a cloud based storage system, or the data storage 112 can be included in the information graph analyzer 102 or a data source 108. In addition, it is to be appreciated that although the analyzer 102 is illustrated as a stand-alone component, such implementation is not so limited. For instance, the analyzer 102 can be associated with or included in a software application, an online shopping portal, and so forth.

The data sources 108 can include virtually any open source or publicly available sources of information, including but not limited to websites, search engine results, social networking websites, online resume databases, job boards, government records, online groups, payment processing services, online subscriptions, and so forth. In addition, the data sources 108 can include private databases, such as credit reports, loan applications, and so forth.

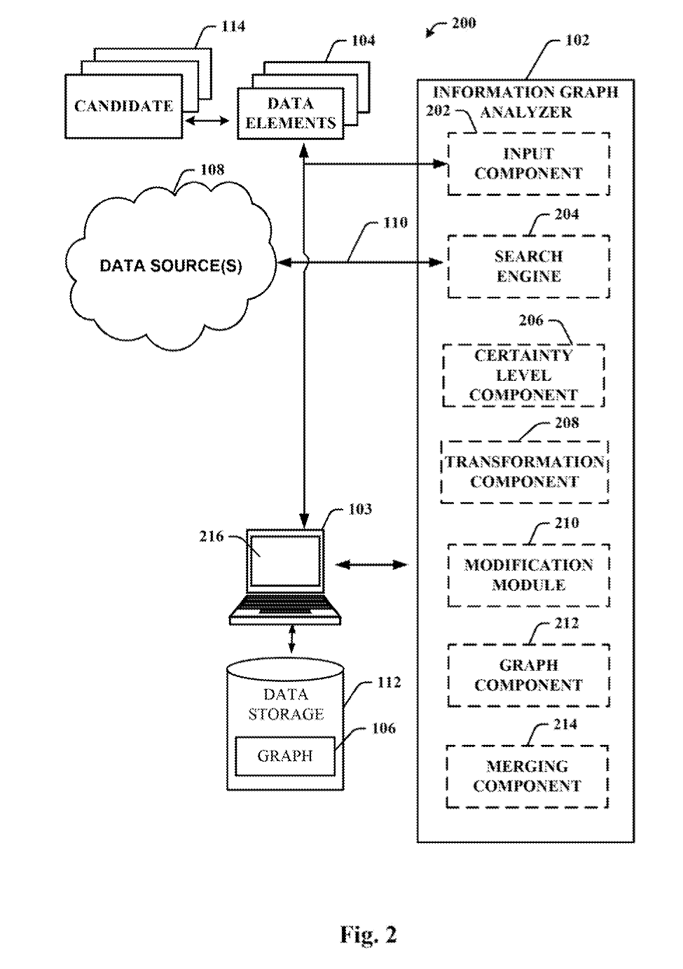

Referring now to FIG. 2, illustrates an example system 200 for generating an information graph for a recommended loan offer to a potential client in accordance with various aspects described herein. As discussed previously, the information graph analyzer 102 can acquire data elements 104 relating to various candidates 114, generate an information graph 106 with a computer unit 103 based at least in part on the data, and further determine an eligibility of a particular subject candidate 114 for one or more offers based at least in part on the levels of certainty of the data elements 104 in the information graph 106. The information graph analyzer 102 includes an input component 202, a search engine 204, a certainty level component 206, a transformation component 208, a modification/augmentation module 210, an information graph component 212 and a merging component 214, for example.

The input component 202 can obtain, acquire, or otherwise receive one or more query terms associated with candidates to be searched. For example, information graph analyzer 102 can execute via a software application wherein the input component 202 can generate one or more user interfaces enabling a user to input initial identifying data. Additionally or alternatively, the identifiers can be input by a disparate user, such as a customer service representative, an agent, etc., or the identifiers can be dynamically obtained from a source, such as the data storage 112 or the data sources 108.

The search engine 204 retrieves data pertaining to a various candidates. The search data includes a set of search terms (e.g., keywords, query terms, etc.). In addition, the search component 204 can identify, ascertain, or otherwise determine a set of data sources 108 to search based on the search terms or identifiers provided. For example, the identifiers can include a set of demographic information (e.g., age, location, etc.) for the user 104, and the search component 204 can determine to search a set of websites (e.g., HTML pages), which may be frequented by users having similar demographic information, or a set of search engines having a high probability of locating information relating to users having similar demographic information. In addition, the search component 204 can perform, direct, or otherwise execute a search on the determined set of data sources 108, and obtain a set of search results for the client identifying data 106. Continuing with the previous example, if the search component 204 determines that information relating to users having similar demographic information can be found via a first and second search engine, then the search component 204 can query the first and second search engine using the search terms.

The certainty level component 208 examines the data sources 108 in which the data elements 104 are retrieved and the information graph 106, and determines a level of certainty for the data elements 104. The level of certainty can be factored according to a reliability of association to candidates represented as candidate nodes in the information graph 106 and/or a reliability of a data source 108 to the data elements 104. Additionally, the certainty level component 206 is operable to update the level of certainty may correspond to relationships of the data elements 104 in the searched results with data elements 104 the information graph 106 as data elements are validated further or merged with a particular candidate 114 in the information graph 106 from a different candidate 114 displayed (e.g., in a display 216) in the information graph 106. For example, if an email for a potential client is searched as the search data, the results may include different domain names in conjunction with dates of birth. A domain name associated with a data of birth for the user name of the email as stored in the client profile would have a higher score for reliance and/or validity than a domain name by itself.

Further, a level of certainty can be provided by the certainty level component 206 based on a frequency of occurrences (e.g., hits) or search results for the given piece of data retrieved (e.g., first set of search results, second set of searches results, etc.). For example, where a client's email is searched, such as with a user name as the identifying data, a domain name occurrence within the results having a greater frequency than others would indicate strong association with the user name, and thus, be afforded a greater level of certainty and ranked greater according to a given scale. The dynamic ranking or measure may be a binary, decimal, scaled on a range, or some weight provided to indicate a relationship or association strength. The certainty level component 206 is further configured to change at least one level of certainty in response to a change of a reliability of association among associations of the data elements 104 with associated candidates in the information graph 106 or updated at least one of the data elements 104 according to new reliable information retrieved.

The updating of the level of certainty measure, for example, is based on a change in a number of the associations among the identifying data, the first set of search results, the second set of search results, and/or the data elements as well as the reliability associated with the data sources 108. In addition, some data elements 104 associated with a particular subject candidate 114 in the information graph 106 can be merged with data elements 104 that are associated with a different candidate when candidates are merged based on a determination that one or more data elements 104 of the particular subject candidate 114 are shared with the different candidate 114 in common. The determination to merge the candidates with respective data elements is based on a condition being met for a predetermined function. For example, where a candidate node displayed in the information graph 106 has one or more data elements 104 of a certain level of certainty (e.g., both one, both greater than five on a scale of 1 to 10, etc.), then all data elements 104 associated with the different candidate are merged with the particular subject candidate 114. The certainty level component 206 is thus configured to update the certainty level associated with shared data elements that are in common with the candidate node and a plurality of different candidates from the information graph 106.

The transformation component 208 examines, inspects, or otherwise analyzes the set of data returned by the search component 204 in a search of data related to a particular subject candidate 114, and transforms the data elements 104 in the information graph 106 and associated candidates, in which the data elements 104 are connected with, into data clusters. For example, data elements 104 are displayed in the information graph 106 as connected to one or more candidate nodes of a plurality of candidate nodes. The data elements 104 associated with each candidate 114 by an edge or a connecting graph link that represents the level of certainty for each data element 104 according to a distance or length of the edge. The transformation component 208 thus clusters the data elements 104 (e.g., candidate attributes, characteristics, etc.) according to candidates that the data elements are associated with. Some data elements may be shared among candidates, while others are only clustered around one candidate.

For example, a certain candidate node of the information graph 106 could be linked to a node indicating that the certain candidate node has a cat. Additionally, another candidate node may also be linked to an element node indicating that this candidate node also has a cat as a common or shared characteristic (data element). Analysis of this information by the transformation component 208 could provide an edge that is a long or short distance from each candidate 114 if the level of certainty is low (e.g., a binary zero, a score of 1-4 on a scale of 1-10, etc.). However, where other data elements 104 indicate a change in the data element represented by the element node indicating that one or both candidates have a cat, then the edge could be shorter or longer depending upon the changing nature of the level of certainty associated with the edge between a candidate 114 and the node element. The information graph 106 is therefore dynamically modified or changed based on updating of information or data elements and their associated level of certainty in relation to particular candidates. For example, where more reliable data sources 108 provide for the same data element, multiple data sources 108 indicate the same element as associated with the client, or where data elements 104 of one candidate 114 are indicated as reliable based on the same and are shared among different candidates, the information graph 106 is able to be dynamically updated in a visual way and ensure accuracy of data clusters at any given point in time.

The information graph analyzer 102 also includes a modification/augmentation module 210 that provides an iterative and dynamic search process to the search engine 204. According to the levels of certainty or validity measures provided to the data elements 104 and various relationships of the data elements 104 stored in the information graph 106, the modification module 210 selects data to modify the identifying data searched as further search data and/or modifies the initial identifying data to increase accuracy and/or relevancy for further information and further validation of the metadata associated in the client's profile. For example, the modification module 210 is configured to select a set of search data from among data elements 104 stored in the data storage 112 that has one or more levels of certainty scores that meet a condition of a predetermined function. Different search results are relevant for inclusion in the information graph 106 based on a correlation with a set of predetermined characteristics, or satisfaction of a condition of a predetermined function. For example, a predetermined function can include, but is not limited to, a relation of a search result to a candidate 114, a trustworthiness of the source from which the search result was obtained, or a classification of the result. For example, if the search engine 204 returns a social networking website profile for a user having the same name as the candidate 114, but the profile information (e.g., data birth, email address, etc.) is different from the data elements 104 known for the candidate 114, then the modification module 210 can determine that the social networking website profile, or information included in the social networking website profile, should not be included in a new set of search data for the client at a subsequent or second search.

Therefore, an iterative and dynamic search process can be performed with each cycle increasing the accuracy, amount, and relevance of the client profile information. Some data could be discarded dynamically. For example, an address may have been discovered to have been changed according to a strong level of certainty being associated with a new address, and thus the new address may update the old address as determined by the modification module 210. Likewise, additional data discovered with modified/augmented identifying data searched by the engine 204 may be added to the client's profile. The various levels of certainty are further updated with each new augmented or modified search that indicates a change in relationship of the data and/or a frequency of occurrences in association with the search or query terms of each iterative search.

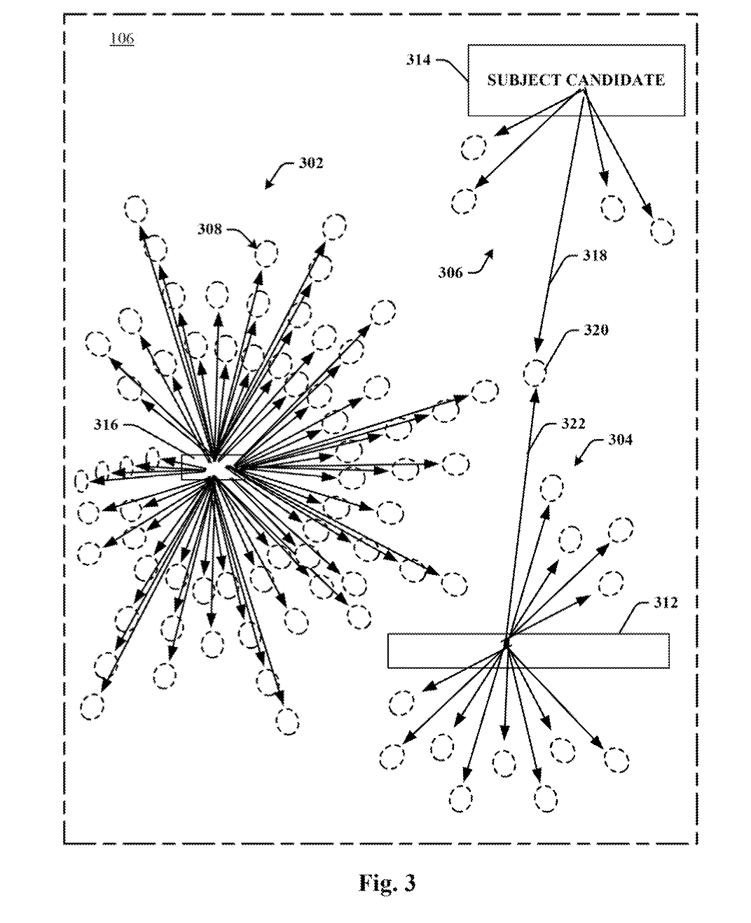

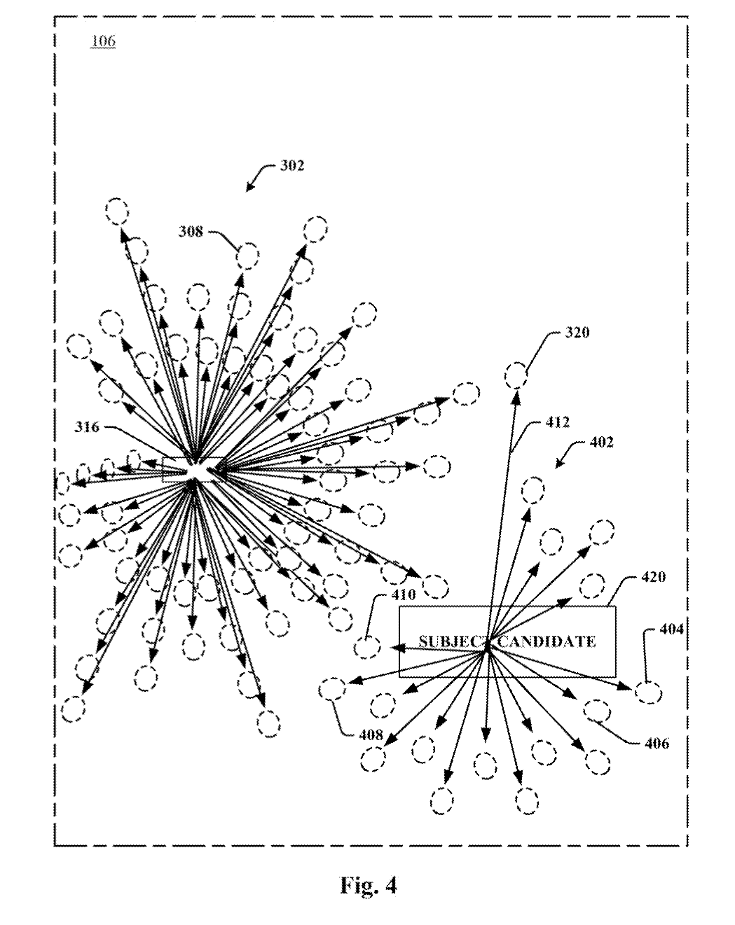

The information graph component 212 and the merging component 214 will be described in detail with reference to FIGS. 3 and 4. The information graph component 212 generates the information graph 106 in the display 216 such as with a graphic microprocessor, processor, controller or the like. For example, the information graph component 212 receives data cluster data generated by the transformation component 208 and displays data clusters 302, 304 and 306 of FIG. 3. The information graph component 212 is configured to generate the information graph 106 with the data clusters 302, 304 and 306 and the associations between them. The information component 212 is also configured to accept instructions from a user to create graphical elements such as candidate nodes, data elements and distances or edges connecting the candidate nodes and data elements.

Data clusters 302, 304 and 306 include data elements, which are each represented by one or more circular element nodes (e.g., element nodes 308). Each data cluster 302, 304 and 306 includes a candidate node 312, 314, and 316 respectively and one or more elemental nodes (e.g., element node 308) connected to each candidate node 312, 314, and 316. The candidate nodes 312, 314, and 316 are each associated with a candidate that is searched among data sources (e.g., data sources 108) for a set of data related to the candidate, which is illustrated as element nodes 308 associated with a data element of the set of data. Each element node 308 can represent, for example, a first name, a last name, a date of birth, age, an email address, user name, domain name, geographical residence, telephone number, history and the like. Further examples of data elements associated with one or more element nodes 308 include factors or attributes related to the person of the candidate, information from public sources, behavioral patterns, interests, age, dependents, spouse profession, area/region of employment, applicant income, spouse income, area/region of residence, homeownership/home value, phone number, years at current residence, years at current job, years client of financial institution issues a loan, credit/debit account availability, hobby, interests, preferences, internet activity statistics, payment delinquency, financial failures, and the like. The data may be information used as identifying data initially as well as searched results discovered and/or updated for each iterative search cycle.

The information graph 106 of FIG. 3 further illustrates edges (e.g., edge 318), which link each element node 308 with a respective candidate node 312, 314, 316. In addition, the edges (e.g., edge 318) the respective data clusters 302, 304, 306 can provide associations in the information graph 106 between data clusters, such as data cluster 306 (a first data cluster) having the candidate 314 (subject candidate), and with a second data cluster 312 where the edge 318 connects the subject candidate 314 with a shared element node 320. The candidate node 312 also has an edge 322 that connects to the shared element node 320.

In one embodiment, each edge (e.g., 320, 322) within the data clusters 302, 304, and 306 include a distance, which can vary according to the level of certainty associated with each edge. Some of the element nodes, for example, are of greater distance from the candidate node in which each is attached, while other element nodes are of a shorter distance.

The merging component 214 is configured to determine whether to merge data clusters 302, 304 and/or 306 in response to associations being identified in the information graph 106 that are among the data clusters 302, 304, and/or 306. For example, FIG. 4 illustrates the information graph 106 with a data cluster that has become a merged single data cluster 402 from a combination of the data cluster 306 and the data cluster 304. A candidate node 420 includes data elements 404, 406, 408, and 410, for example that were originally data elements attached to candidate node 314, and also includes the data elements connected to the candidate node 312 of FIG. 3. The candidate node 420 thus comprises a combination of the subject candidate node 314 and candidate node 312, and further has the data elements previously connected to each candidate node 312, 314 now connected to the candidate node 420. The candidate node 420 remains the subject candidate associated with a subject person for offering a financial product thereto.

In one embodiment, the merging component 214 determines to merge the data cluster 304 with the data cluster 306 in response to the associations determined in the information graph between the data cluster 306 and the data cluster 304. The merging component 214 assesses whether to merge data cluster based on whether edges in the information graph 106 meet a condition for a predetermined function. For example, a condition can be a certain number threshold of data elements functioning as shared data elements among data clusters, such as the shared data element 320.

In an another embodiment, the merging component 214 determines to merge data clusters according to one or more of the data elements of one data cluster being equal to one or more data elements of a different second data cluster. For example, a first candidate could be graphed as the candidate node 314 and have the data element 320 associated with it by the edge 318. If the data element 320 represents a birth date, of the candidate represented by the candidate node 314, and the data element 320 is shared with a different candidate node, then the candidates of each candidate node are determined to be equal and the respective data clusters 306 and 306 are merged. When merging the data clusters, the merging component merges all data elements into one candidate, even if less than all of the data elements of the data cluster are not shared. In addition, various conditions are used for the merging component 214 in making a determination to merge the data clusters. According to different levels of certainty associated with and differing among the data elements, different formula functions can be used to determine if a merging condition is met. For example, where the levels of certainty are an average, a mean or some other indication that a shared data element has a reliability of association to each candidate then this factor may be weighted as a greater variable. In addition, different numbers of shared data elements could be factored together with the reliability of association to provide a confidence that candidates are similar enough to be merged together as one. While not all data elements may actually be a one hundred percent level of certainty, nor all data elements not shared, but still merged together may belong to the subject candidate with absolute certainty, the merged data cluster still provides further data elements to similar candidates for comparison or as more data points in determining characteristics that may benefit a decision to offer a financial product.

Referring again to FIG. 2, the merging component 206 with the modification module 210 is further configured to modify, alter, or otherwise update the set of keywords, the metadata stored data elements, the levels of certainty, and/or the set of data sources 108 based at least in part on the set of search results returned by the search engine 204. For example, where search results contain an alias used by the candidate 104, and the merging component 214 can include the alias in the set of keywords. As an additional example, the modification component 210 is configured to update the set of sources 108 based on information, such as an additional email address returned by the query component 404 for the user 104. For instance, if the search engine 204 locates an internet email address associated with the user 104, wherein the internet email is hosted by a first social networking site (e.g., user@1stsocialnetwork.com), then the merging component 406 with the modification module 210 can include the first social networking site in the set of sources 108.

In one embodiment, the merging component 206 signals the certainty level component 206 to dynamically update the levels of certainty in response to a determination to merge data clusters into a single data cluster. For example, the merged edges of the information graph, such as merged edge 412 of FIG. 4 could be an altered distance or provide for a modified level of certainty attached, such as an average, a sum, or some function of the two levels of certainty associated with the respective candidates.

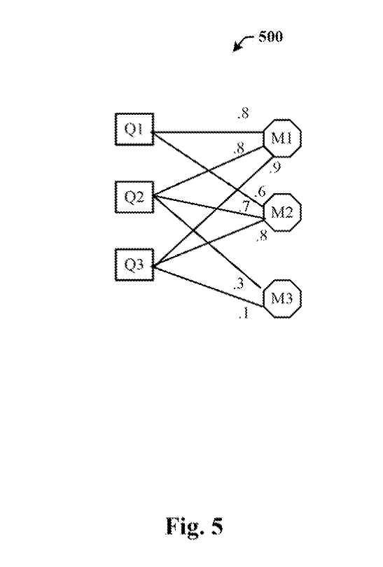

For example, FIG. 5 illustrates a graph 500 that provides for different search queries (e.g., Q1, Q2, and Q3) and ascertaining levels of certainty candidates and data elements pertaining to the candidates with the certainty level component 206 in FIG. 2. Q1 initiates with a set of data that is searched, and that also relates to a candidate. The data elements retrieved in the search results are M1 and M2 and an initial level of certainty is determined by as 0.8 and 0.6 at each relationship, as indicated by the lines connecting Q1 with M1 and M2.

For example, an initial search cycle based on keywords or identifying data using the name: Jack Smith, data of birth: 26 Jan. 1916 and email: address@email.com. The results returned a new email address, a pseudo-name from a social network, an alias, a blog nickname, a service username, and/or any other character data related. Subsequently, in a further search (e.g., Q2, Q3, etc.) the results are employed to modify the existing data in Q1 or add to the data already stored from previous search results.

Subsequently, Q2 is a modified search that is performed with augmented or changed identifying data or search terms. In other words, new information resulting from M1 and M2 may supplement the identifying data or search terms used in Q1. Alternatively, Q2 is updated data resulting from a search with Q1, such as a new address or the like. Each data is relevant to different degrees to the creditworthiness of the potential client, and thus, is searched to determine and iteratively increase improve the validity and accuracy. Subsequently, Q2 is searched and returns M1, M2 and also M3 pieces of data related to the searched information data. According, to the different relationships analyzed by the information graph analyzer 102, the certainty level component 206 provides a level of certainty to each relationship, and/or to each data element or metadata M1, M2 and M3. In addition, each new search, such as M3 further improves the calculation and either confirms the validity or negates the metadata discovered as not valid. In addition, scores may change not only as new data is discover (e.g., M3), but also as data from previous results has a difference in frequency in relation to the identifying data in used in the search or is further related to other metadata either used as search terms or stored in the profile of the client.

For example, before each new search cycle is started, the new attributes or related metadata affiliated to the subject candidate are confirmed. This may be done by assigning a rating to each match. A higher rating or validation score from the certainty level component 206 indicates a higher level of certainty that information belongs to the search subject and is valid. For example, an email address is a unique ID, therefore, if discovered that a user profile includes the same email address, there is a very high level of certainty attributed to the email address. Alternatively, matching a name or date of birth offers considerably low level of certainty. However, matching the name and the date of birth improves the quality of the match. Similarly, although a username usually is a unique ID within the same domain, it may belong to a different entity at a different domain. Although matching a name, date of birth and the username from two different domains provides very high probability that one and the other entities are the same.

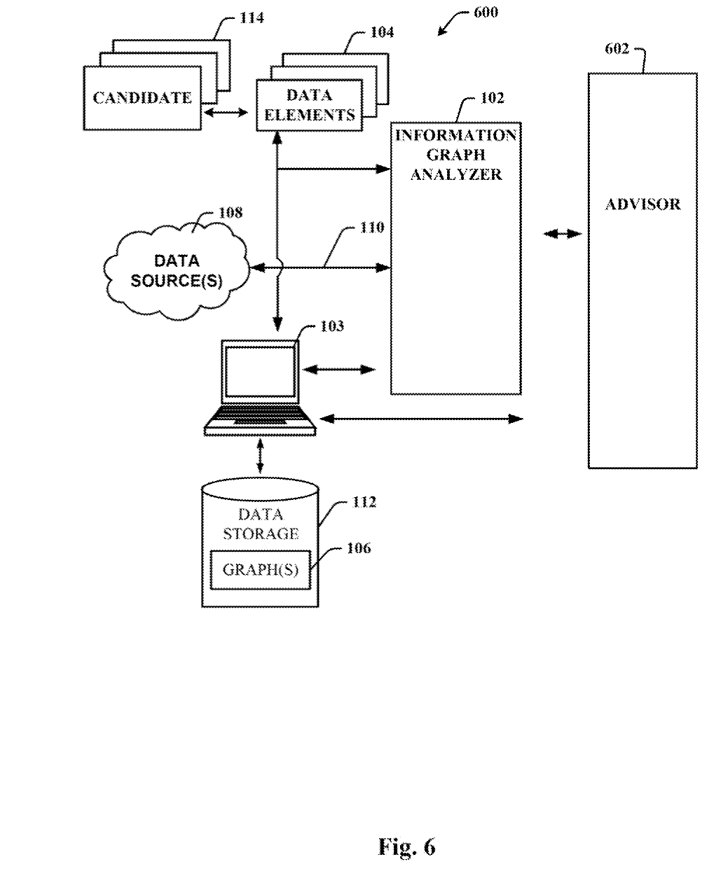

Turning now to FIG. 6, illustrated is an example of a system 600 with an advisor component 602 in accordance with various aspects described herein. The advisor component 602 is communicatively coupled to the information graph analyzer 102 and provides feedback to the processing unit 103 where a user can receive output recommendations.

The advisor component 602 obtains data from the information graph analyzer 102. For example, the information graph analyzer 102 generates measures that are based on the data relationships and/or frequency of occurrence of data in the different search results with respect to data elements collected in the information graph 106 from iterative searching by the system. The measures (e.g., levels of certainty, reliability of data sources, and/or reliability of associations) are thus interpreted by the advisor component 602 as a probability that the data elements 104 modified/augmented with each new search are associated with the client and from reliable data sources 108. The levels of certainty can be used by the advisor component 602 to determine a reliability factor, in which the advisor used to factor a credit-worthiness score over time for a loan over or other financial product. The credit worthiness score may involve any number of factors and is not limited to only the reliability factor of the information gathered about the candidate, but in some embodiments may be factored only on the reliability factors and/or validity scores. In response to the client profile being dynamically updated, as discussed above, the advisor component 602, for example, alters a loan offer or the recommendations outputted from the system based on the validity scores. Consequently, the advisor component 602 is configured to generate a loan offer to a potential candidate based on the information graph being dynamically updated from public available sources or sources that are always available on a network, such as a wide area network or the like.

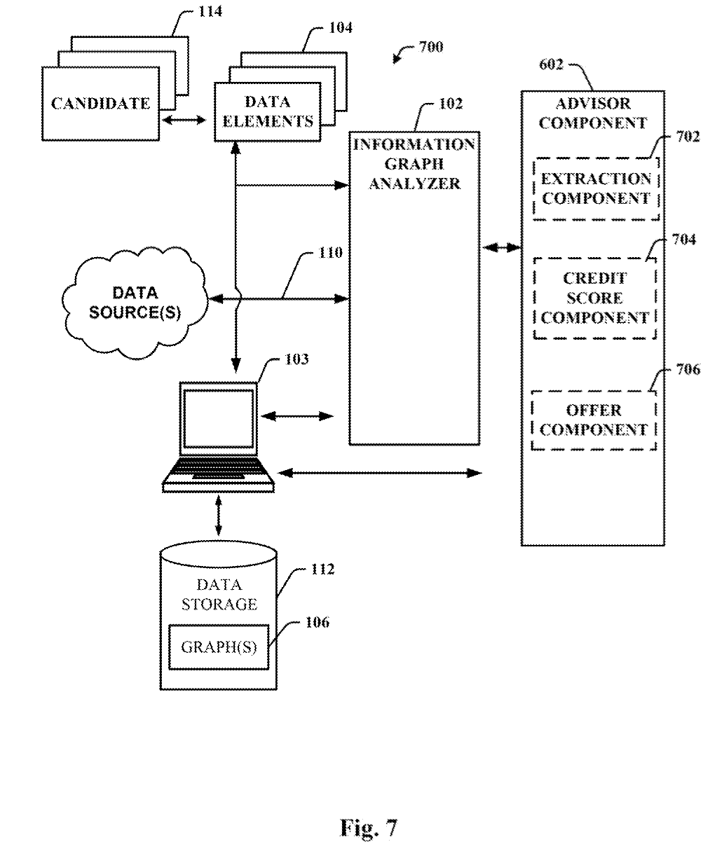

Referring now to FIG. 7, illustrates an exemplary advisor component 602 of the system. The component 602 includes an extraction component 702, a credit-worthiness score component 704 and an offer component 706. Each component is communicatively coupled to one another to dynamically generate an output based upon a dynamically generated information graph regarding a candidate for a financial offer, such as for a financial loan or other financial product.

The extraction component 702 retrieves, obtains or otherwise extracts data from the profile analyzer. Data is also communicated to the advisor component 602 from the information graph analyzer, for example, and received at the extraction component 702. The extraction component 702 retrieves data needed to provide a recommended output to a user of the system. For example, a candidate may be provided a loan offer, a set of financial instruments approved for, and/or a range of investment offers. The extraction component 702 communicates the data as an interface to the credit worthiness score component 704. A client's credit score is calculated at the credit-worthiness component based on the data dynamically updated in the information graph 106 and communicated by the extraction component 702. The score may be any scored weighted with different factors in an equation or algorithm as one of ordinary skill in the art will appreciate. For example, the validity and relevance of the data accumulated about the client is used as a factor or as the basis for a credit-worthiness score calculation. The offer component 706 then provides various terms, instruments, ranges, financial numbers and the like for presenting to the client.

Additionally, the offer component 706 intelligently determines or infers categorization of the profile 106, approval for one or more offers, or a set of terms for the offers. Any of the foregoing inferences can potentially be based upon, e.g., Bayesian probabilities or confidence measures or based upon machine learning techniques related to historical analysis, feedback, and/or other determinations or inferences.

While the methods described within this disclosure are illustrated in and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

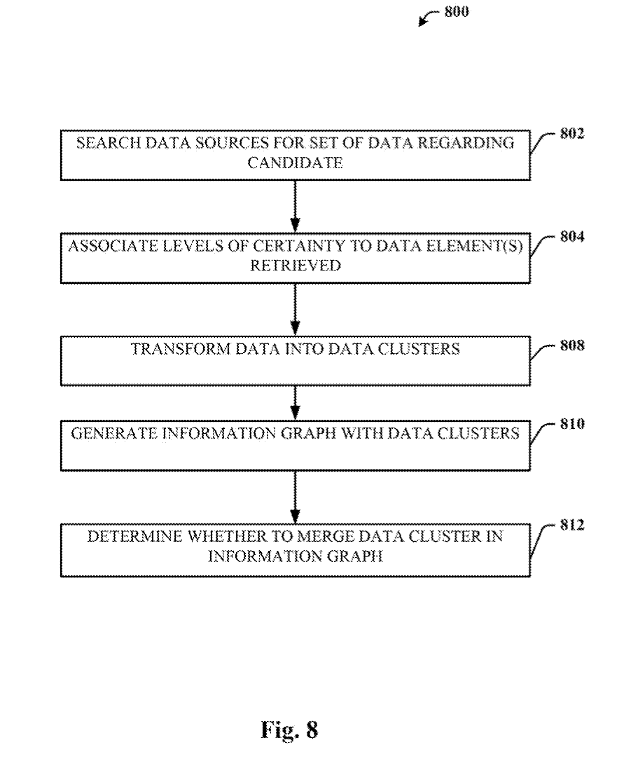

An example methodology 800 for implementing a method for a recommendation system is illustrated in FIG. 8. Reference may be made to the figures described within this disclosure for ease of description. However, the method 800 is not limited to any particular embodiment or example provided within this disclosure.

FIG. 3 illustrates the exemplary method 300 for a recommendation system 100 in accordance with aspects described herein. The method 300, for example, provides for a system to dynamically and iteratively search data sources 108 regarding a plurality of candidates 114 based on automatic augmentation or modification of the search terms (e.g., identifying data) related to the client while also dynamically and iteratively validating the data stored in an information graph 106 from each search. An output or recommendation, such as a recommendation for a loan is based on the level of certainty of the data displayed within the information graph to provide actionable visual knowledge about clusters of candidates and a subject candidate. Consequently, a more accurate and reliable information of a candidates is obtained to serve a ready credit worthiness score on behalf of potential clients before even applying for a loan or other financial arrangement, for example. Analysis of the dynamically generated and updated information graph 106 allows users of the system 100 to discover links from one subject candidate to another candidate through common characteristics based on data clustering. Candidates are merged so that characteristics of one candidate belong to another candidate and objects within the information graph are merged accordingly. In this way, characteristics of potential clients or candidates are dynamically updated as new data is searched, updated and discovered to relate among candidates. This ensures a high validity and constant updating of information related to candidates. Certain characteristics may be considered reliable and manually programmed or automatically learned through Fuzzy logic, neural networking, or artificial intelligence filtering. For example, a birthday, an avatar, Email, ICG username/identification, LinkedIn username, Open identification, personal blog, phone number, Skype identification, some other social network identification or identifying characteristics, etc may be information and data sources considered reliable and provided with a level of certainty greater than other information sources.

At 802, a search of data sources for a set of data regarding a one or more candidates is conducted. The set of data includes data elements (e.g., characteristics, attributes or identifying data related to each candidate). A set of identifying data (e.g., identifiers, application fields, key words, etc.) can be received and utilized as search terms, user information, signature data, symbols and the like for executing a query for a subject matter or a potential client. For example, the set of identifying data can include a first name, a last name, a birth date, age, an email address, user name, domain name, geographical residence, telephone number, history and any other characteristic data. As discussed previously, the identifying data can be received from the user, extracted from a form extraction system, a disparate user (e.g., customer service representative, agent, etc.), obtained from a data store, or an associated profile and from any trusted source of data. A set of data sources is searched for information regarding the user based on the identifying data received. The characteristics or data retrieved are represented as element nodes or data elements within an information graph. The data sources can include virtually any open source or publicly available sources of information, including but not limited to websites, search engine results, social networking websites, online resume databases, job boards, government records, online groups, payment processing services, online subscriptions, and so forth. In addition, the data sources can include private databases, such as credit reports, loan applications, and so forth.

At 804, levels of certainty are provided to the set of data retrieved or to the data elements respectively. An information graph of candidate characteristics can be initially populated in a memory of the system based on the search results. The information graph of candidate characteristics (metadata) can include data from the search results that corresponds, correlates, or otherwise matches a set of predetermined characteristics for determining financial offer eligibility.

At 806, data retrieved is transformed into data clusters. A candidate node in the information graph is associated with each candidate. Element nodes are associated with data elements of the set of data retrieved about candidates. In addition, one or more edges connect data elements to a related candidate node and that also include the level of certainty for the data element that the node connects. The data retrieved can be transformed into data clusters based on the data elements retrieved and the level of certainty associated with each data element.

The identifying data provided to obtain the search results can be modified with search data from the information graph constructed. The modification can alter, augment, or otherwise reconfigure data stored in the profile. In other words, data elements in the information graph of the candidate can be automatically selected to augment/modify the original data. The data can be used to further enhance the search for client data and further iteratively and dynamically update the information graph at each cycle of augmentation/modification of the set of data initially searched.

At 810, the information graph is generated with the data clusters where a subject candidate is compared to other candidates compiled. Relationships among the data and frequency of associations between data clusters are analyzed and used to provide a validity measure in which a creditworthiness score is determined. For example, where the information obtained about the client has a high validity and relevance to the client's credit score, a confidence or reliability score can be determined that results in a corresponding suitable loan offer to be recommended for the potential client. The edges can further be illustrated to demonstrate a level of certainty by a distance or length of the edge, in which the edge connecting a data element with a respective candidate.

At 812 a determination is made based on the associations within and among the data cluster in the information graph whether to merge data clusters within the information graph. A single data cluster may be formed from one or more other data clusters. A single data cluster includes a candidate node associated with a candidate, one or more element nodes, one or more edges, different elements nodes that were related to a different candidate node before being merged, and edges connecting them.

The information graph is dynamically analyzed to determine the accuracy of the information included in the profile, and the relevancy of the information to determine eligibility for a client offer. The accuracy is determined by comparing the information to other known information, or additional search results, and generating a level of certainty indicating a confidence level of the information based at least in part on the comparison. If the level of certainty is within a predetermined confidence threshold or range, then the information is determined to have a high level of accuracy and be reliable. Additionally, the validation score can be generated based at least in part on whether the data satisfies a set of verification criterion. The relevancy of the information to the offer eligibility determination is determined based at least in part on a set of offer criterion. For example, the set of offer criterion for a loan can include a set of predetermined characteristics, such as age, gender, profession, income, residence, education, debt, and so forth, and if the data information included in the profile correlates to the criterion, then it is deemed relevant to a degree. Consequently, a loan offer or other financial product can be presented to a client based on the information graph.

### Exemplary Networked and Distributed Environments

One of ordinary skill in the art can appreciate that the various non-limiting embodiments of the shared systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

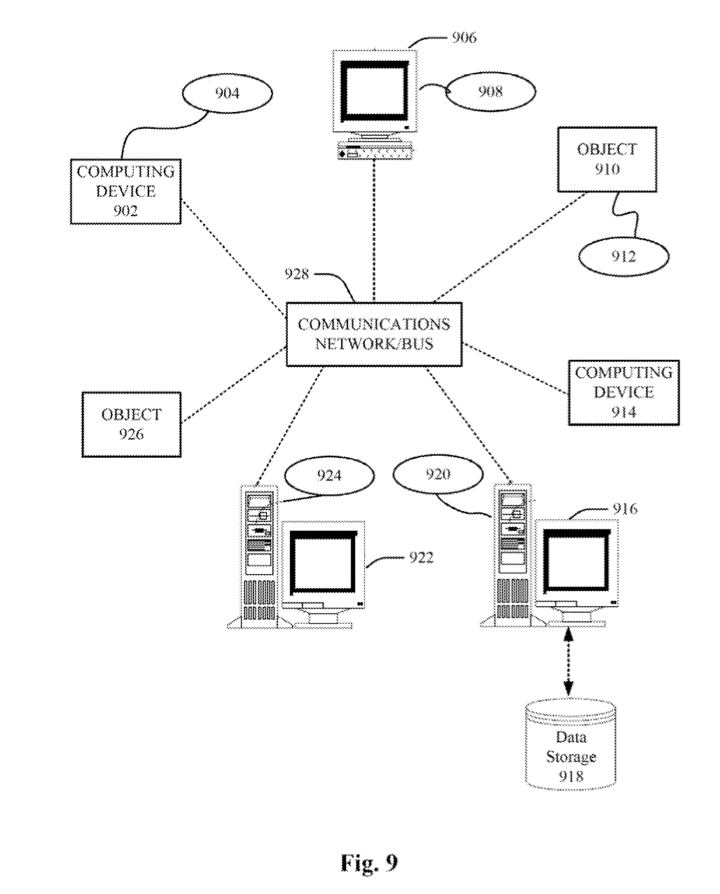

FIG. 9 provides a schematic diagram of an exemplary networked or distributed computing environment. The distributed computing environment comprises computing objects 910, 912, etc. and computing objects or devices 920, 922, 924, 926, 928, etc., which may include programs, methods, data stores, programmable logic, etc., as represented by applications 930, 932, 934, 936, 938. It can be appreciated that computing objects 910, 912, etc. and computing objects or devices 920, 922, 924, 926, 928, etc. may comprise different devices, such as personal digital assistants (PDAs), audio/video devices, mobile phones, MP3 players, personal computers, laptops, etc.

Each computing object 910, 912, etc. and computing objects or devices 920, 922, 924, 926, 928, etc. can communicate with one or more other computing objects 910, 912, etc. and computing objects or devices 920, 922, 924, 926, 928, etc. by way of the communications network 940, either directly or indirectly. Even though illustrated as a single element in FIG. 9, communications network 940 may comprise other computing objects and computing devices that provide services to the system of FIG. 9, and/or may represent multiple interconnected networks, which are not shown. Each computing object 910, 912, etc. or computing object or device 920, 922, 924, 926, 928, etc. can also contain an application, such as applications 930, 932, 934, 936, 938, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 9, as a non-limiting example, computing objects or devices 920, 922, 924, 926, 928, etc. can be thought of as clients and computing objects 910, 912, etc. can be thought of as servers where computing objects 910, 912, etc., acting as servers provide data services, such as receiving data from client computing objects or devices 920, 922, 924, 926, 928, etc., storing of data, processing of data, transmitting data to client computing objects or devices 920, 922, 924, 926, 928, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 940 or bus is the Internet, for example, the computing objects 910, 912, etc. can be Web servers with which other computing objects or devices 920, 922, 924, 926, 928, etc. communicate via any of a number of known protocols, such as the hypertext transfer protocol (HTTP). Computing objects 910, 912, etc. acting as servers may also serve as clients, e.g., computing objects or devices 920, 922, 924, 926, 928, etc., as may be characteristic of a distributed computing environment.

### Exemplary Computing Device

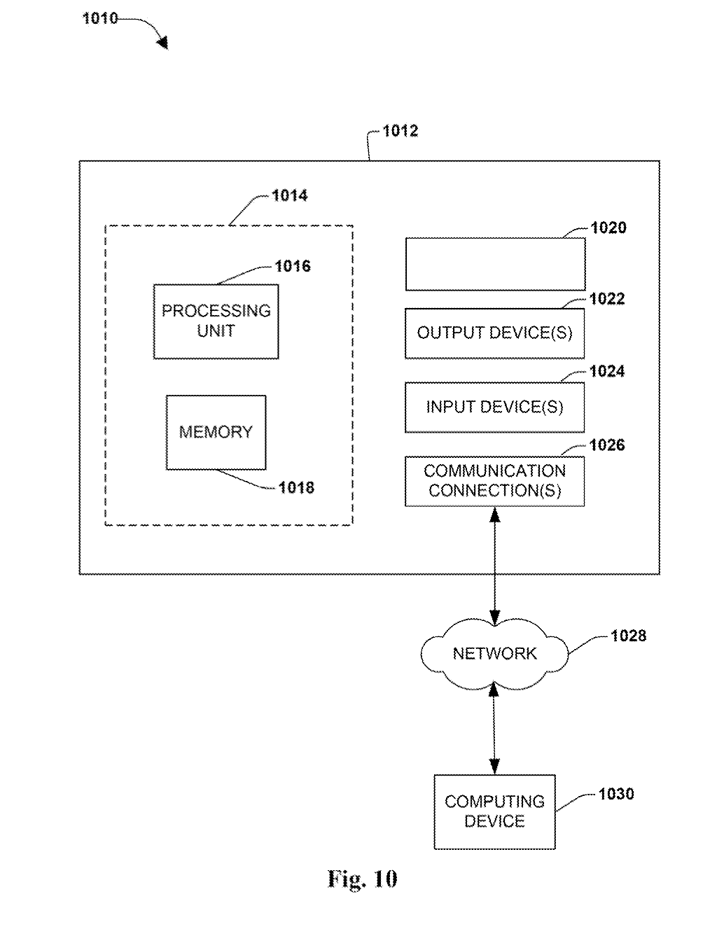

As mentioned, advantageously, the techniques described herein can be applied to a number of various devices for employing the techniques and methods described herein. It is to be understood, therefore, that handheld, portable and other computing devices and computing objects of all kinds are contemplated for use in connection with the various non-limiting embodiments, i.e., anywhere that a device may wish to engage on behalf of a user or set of users. Accordingly, the below general purpose remote computer described below in FIG. 10 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 10 and the following discussion provide a brief, general description of a suitable computing environment to implement embodiments of one or more of the provisions set forth herein. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 10 illustrates an example of a system 1010 comprising a computing device 1012 configured to implement one or more embodiments provided herein. In one configuration, computing device 1012 includes at least one processing unit 1016 and memory 1018. Depending on the exact configuration and type of computing device, memory 1018 may be volatile (such as RAM, for example), non-volatile (such as ROM, flash memory, etc., for example) or some combination of the two. This configuration is illustrated in FIG. 10 by dashed line 1014.

In other embodiments, device 1012 may include additional features and/or functionality. For example, device 1012 may also include additional storage (e.g., removable and/or non-removable) including, but not limited to, magnetic storage, optical storage, and the like. Such additional storage is illustrated in FIG. 10 by storage 1020. In one embodiment, computer readable instructions to implement one or more embodiments provided herein may be in storage 1020. Storage 1020 may also store other computer readable instructions to implement an operating system, an application program, and the like. Computer readable instructions may be loaded in memory 1018 for execution by processing unit 1016, for example.

The term “computer readable media” as used herein includes computer readable storage media and communication media. Computer readable storage media includes volatile and nonvolatile, removable and non-removable media implemented in any method or technology for storage of information such as computer readable instructions or other data. Memory 1018 and storage 1020 are examples of computer readable storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Any such computer readable storage media may be part of device 1012.

Device 1012 may also include communication connection(s) 1026 that allows device 1012 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computer readable media” may also include communication media. Communication media typically embodies computer readable instructions or other data that may be communicated in a “modulated data signal” such as a carrier wave or other transport mechanism and includes any information delivery media. The term “modulated data signal” may include a signal that has one or more of its characteristics set or changed in such a manner as to encode information in the signal.

Device 1012 may include input device(s) 1024 such as keyboard, mouse, pen, voice input device, touch input device, infrared cameras, video input devices, and/or any other input device. Output device(s) 1022 such as one or more displays, speakers, printers, and/or any other output device may also be included in device 1012. Input device(s) 1024 and output device(s) 1022 may be connected to device 1012 via a wired connection, wireless connection, or any combination thereof. In one embodiment, an input device or an output device from another computing device may be used as input device(s) 1024 or output device(s) 1022 for computing device 1012.

Components of computing device 1012 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1012 may be interconnected by a network. For example, memory 1018 may be comprised of multiple physical memory units located in different physical locations interconnected by a network.

Those skilled in the art will realize that storage devices utilized to store computer readable instructions may be distributed across a network. For example, a computing device 1030 accessible via network 1028 may store computer readable instructions to implement one or more embodiments provided herein. Computing device 1012 may access computing device 1030 and download a part or all of the computer readable instructions for execution. Alternatively, computing device 1012 may download pieces of the computer readable instructions, as needed, or some instructions may be executed at computing device 1012 and some at computing device 1030.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method, comprising:
executing, by a computing device including at least one processor, a search of a first set of data that is related to a first candidate;
associating the first set of data with a first level of certainty;
transforming the first set of data into a first data cluster for representation in display based on the first set of data and the first level of certainty;
executing, by the computing device, a different search of a second set of data related to a second candidate;
associating the second set of data with a second level of certainty;
transforming the second set of data into a second data cluster for representation in display based on the second set of data and the second level of certainty;
generating an information graph with the first data cluster and the second data cluster for further representation in display; and
determining associations of the information graph between the first data cluster and the second data cluster, and based on the associations, determining whether to merge the first data cluster and the second data cluster in the information graph into a merged data cluster that is associated with the first candidate.

2. The method of claim 1, further comprising:
determining an eligibility of the first candidate to provide at least one financial offer based at least in part on the information graph.

3. The method of claim 1, wherein the transforming the first set of data into the first data cluster includes determining first edges, for representation in display, connecting a first candidate node associated with the first candidate to first data elements of the first set of data based on the first level of certainty, wherein the first level of certainty differs among the first data elements of the first set of data according to a reliability of a data source for the first data elements.

4. The method of claim 3, wherein the transforming the second set of data into the second data cluster includes providing second edges in the display connecting a second candidate node associated with the second candidate to second data elements of the second set of data based on the second level of certainty, wherein the second level of certainty differs among the second data elements of the second set of data according to a reliability of a data source for the second data elements.

5. The method of claim 4, further comprising:
merging the first data cluster and the second data cluster in the information graph into the merged data cluster including merging the first candidate node and the second candidate node into a single candidate node having the first set of data and the second set of data, in response to a determination to merge the first data cluster and the second data cluster into the merged data cluster that is associated with the first candidate.

6. The method of claim 4, further comprising determining a length of the first edges and the second edges based on the first level of certainty and the second level of certainty respectively.

7. The method of claim 1, wherein the determining the associations in the information graph between the first data cluster and the second data cluster includes identifying the associations between first data elements of the first set of data and second data elements of the second set of data and determining the first level of certainty and the second level of certainty between each association based on a reliability of a data source from which the first data elements and the second data elements are retrieved by the search and on a reliability of association between the first candidate with the first data elements and the second data elements.

8. The method of claim 1, wherein the determining the associations in the information graph between the first data cluster and the second data cluster further includes assessing whether edges in the display connecting each of the associations meet a condition for a predetermined function.

9. The method of claim 1, further comprising:
merging the first data cluster and the second data cluster in the information graph into the merged data cluster, in response to a determination to merge the first data cluster and the second data cluster into the merged data cluster that is associated with the first candidate, according to one or more first data elements of the first set of data being equal to one or more second data elements of the second set of data and according to the first level of certainty associated with the one or more first data elements of the first set of data and the second level of certainty associated with the one or more second data elements of the second set of data.

10. The method of claim 1, further comprising:
determining the first level of certainty and the second level of certainty based on a reliability associated with one or more data sources from which at least one data element of the first set of data and at least one data element of the second set of data are retrieved by the search.

11. The method of claim 10, wherein the determining the first level of certainty and the second level of certainty further comprises determining the first level of certainty and the second level of certainty based on a reliability of association that the at least one data element of the first set of data and the at least one data element of the second set of data are associated with the first candidate and the second candidate respectively.

12. The method of claim 11, further comprising:
dynamically determining a credit worthiness score associated with a loan offer for the first candidate based upon the first level of certainty in the information graph, wherein the first level of certainty is updated based on a determination to merge the first data cluster and the second data cluster into the merged data cluster.

13. The method of claim 12, wherein the determining the credit worthiness score for the first candidate includes analyzing the information graph, classifying the first candidate and the first set of data based at least in part on the analyzing, and determining the credit worthiness score for the loan offer based at least in part on the classifying.

14. The method of claim 1, further comprising:
dynamically updating the first level of certainty in response to a determination to merge the first data cluster and the second data cluster into the merged data cluster; and
generating a single candidate node associated with the first candidate and first edges connecting the single candidate node with first data elements of the first data cluster and second edges connecting the single candidate node with second data elements of the second data cluster.

15. The method of claim 1, further comprising:
merging the first data cluster and the second data cluster in the information graph into the merged data cluster in response to a determination to merge the first data cluster and the second data cluster into the merged data cluster, wherein less than all first data elements of the first set of data are equal to less than all second data elements of the second set of data.

16. A computer readable storage medium comprising computer executable instructions that, in response to execution by a computing system, cause the computing system to perform operations, comprising:
executing, via a search engine, a search of one or more data sources and retrieving a set of data related to a candidate;
associating a level of certainty to one or more data elements of the set of data;
transforming, for display in the computing system, the set of data into a data cluster based on the one or more data elements and the level of certainty, including:
generating a candidate node associated with the candidate;
generating one or more element nodes of the one or more data elements; and
generating one or more edges that respectively connect the candidate node with the one or more element nodes and that include the level of certainty for the one or more data elements of the set of data;
executing, via the search engine, a search for data elements of a plurality of different candidates;
transforming, for display in the computing system, the data elements of the plurality of different candidates into different data clusters associated with different candidates;
generating an information graph with the data cluster and the different data clusters in the display; and
determining associations in the information graph between the data cluster and the different data clusters, and based on the associations, determining whether to merge the data cluster with at least one of the different data clusters in the information graph into a merged data cluster.

17. The computer readable storage medium of claim 16, further comprising:
merging the data cluster with the at least one of the different data clusters in the information graph into the merged data cluster in response to a determination to merge, wherein the merged data cluster includes the candidate node associated with the candidate, the one or more element nodes, the one or more edges, different element nodes related to the data elements of the at least one of the different data clusters, and edges connecting the candidate node with the data elements of the at least one of the different data clusters.

18. The computer readable storage medium of claim 17, further comprising:
associating a different level of certainty to the data elements of the plurality of different candidates;
wherein the determination to merge includes factoring the different level of certainty and the level of certainty of the one or more data elements to determine whether a condition is met for a predetermined function.

19. The computer readable storage medium of claim 18, wherein less than all of the set of data is equal to less than all of the data elements of the at least one of the different data clusters.

20. The computer readable storage medium of claim 18, further comprising:
updating the merged data cluster for the candidate in the information graph as subsequent searches for the data elements of the plurality of different candidates changes the different level of certainty associated with shared data elements that are in common with the candidate node and the plurality of different candidates.

21. The computer readable storage medium of claim 18, wherein the level of certainty and the different level of certainty are provided in the information graph in the display according to a length of each edge.

22. The computer readable storage medium of claim 16, further comprising:
determining an eligibility of the candidate to provide at least one financial offer based at least in part on the information graph.

23. A system, comprising:
a search engine configured to generate search results with a computing device including at least one processor, wherein the search results have a first set of data that is related to a first candidate and a second set of data related to a second candidate;
a certainty level component configured to associate the first set of data with a first level of certainty, and the second set of data with a second level of certainty;
a transformation component configured to transform, for representation in display, the first set of data into a first data cluster based on the first set of data and the first level of certainty and the second set of data into a second data cluster based on the second set of data and the second level of certainty;
an information graph component configured to generate an information graph, for further representation in display, with the first data cluster and the second data cluster; and
a merging component configured to determine associations of the information graph between the first data cluster and the second data cluster, and to determine, based on the associations, whether to merge the first data cluster and the second data cluster in the information graph into a merged data cluster that is associated with the first candidate.

24. The system of claim 23, further comprising:
an advisor component configured to determine an eligibility of the first candidate and determine at least one financial offer based at least in part on the information graph, and to dynamically determine a credit worthiness score associated with a loan offer for the first candidate based upon the first level of certainty in the information graph, wherein the first level of certainty is updated based on a determination to merge the first data cluster and the second data cluster into the merged data cluster, wherein the determining the credit worthiness score for the first candidate includes analyzing the information graph, classifying the first candidate and the first set of data based at least in part on the analyzing, and determining the credit worthiness score for the loan offer based at least in part on the classifying.

25. The system of claim 23, the information graph component is further configured to provide first edges, for representation in display, connecting a first candidate node associated with the first candidate to data elements of the first set of data based on the first level of certainty, wherein the first level of certainty differs among the respective data elements according to a reliability of data sources for data elements of the first set of data, wherein the information graph is further configured to provide second edges, for representation in, display connecting a second candidate node associated with the second candidate to data elements of the second set of data based on the second level of certainty, wherein the second level of certainty differs among the data elements of the second set of data according to a reliability of data sources for data elements of the second set of data.

26. The system of claim 25, wherein the information graph is further configured to determine a length of each edge based on the first level of certainty or the second level of certainty.

27. The system of claim 23, wherein the merging component is further configured to merge the first data cluster and the second data cluster in the information graph into the merged data cluster according to a determination that one or more data elements of the first set of data are equal to one or more data elements of the second set of data, and according to the first level of certainty associated with the one or more data elements of the first set of data and the second level of certainty associated with the one or more data elements of the second set of data.

28. The system of claim 27, wherein the merging component is configured to make the determination to merge when less than all of the first set of data is equal to less than all of the second set of data.

29. The system of claim 23, wherein the merging component is further configured to identify one or more associations between data elements of the first set of data and data elements of the second set of data and

30. The system of claim 23, wherein the certainty level component is further configured to determine the first level of certainty and the second level of certainty of each association based on a reliability of a data source from which data elements of the first set of data and the second set of data are retrieved by the search engine and on a reliability of association between the data elements of the first and the second set of data with the first candidate.

31. A system, comprising:
means for searching to retrieve data elements of a set of data related to a candidate from a set of data sources and for different data elements of a plurality of different candidates;
means for associating respectively a level of certainty to the data elements of the set of data and different levels of certainty to the data elements of the plurality of different candidates;
means for transforming the set of data into a data cluster based on the set of data and the level of certainty and transforming the data elements of the plurality of different candidates into different data clusters;
means for generating an information graph with the data cluster and the different data clusters for representation in display; and
means for determining associations in the information graph between the data cluster and the different data clusters and determining whether to merge the data cluster with at least one of the different data clusters in the information graph into a merged data cluster.

32. The system of claim 31, further comprising:
means for advising an eligibility of the candidate for a loan offer based at least in part on the information graph.
